(19) United States
(12) Patent Application Publication
(10) Pub. No.: US 2023/0186149 A1
(43) Pub. Date: Jun. 15, 2023

(54) MACHINE LEARNING BASED STABILIZER FOR NUMERICAL METHODS

(71) Applicant: Advanced Micro Devices, Inc., Santa Clara, CA (US)

(72) Inventors: Saketh Venkata Rama, Wakefield, MA (US); Ganesh Dasika, Austin, TX (US); Laurent S. White, Austin, TX (US)

(21) Appl. No.: 17/550,882

(22) Filed: Dec. 14, 2021

(51) Int. Cl. G06N 20/00

(52) U.S. Cl. CPC G06N 20/00

(57) ABSTRACT

An approach is provided for using machine learning to provide compensation for roundoff error in algorithmic computations. The approach includes training a machine learning model based low precision data and corresponding high precision data. The low precision data includes pairs of low precision values of a specific datatype that correspond to pairs of high precision values from the high precision data. The high precision data includes pairs of high precision values of a specific datatype that correspond to the pairs of low precision values from the low precision data. When the machine learning model has been trained, the machine learning model is used as a basis for determining a compensation value is used to compensate for roundoff error in a particular algorithmic computation. Techniques discussed herein provide compensation for roundoff error during otherwise unstable computations, enabling high-performance computing and other scientific applications to use lower precision data types more readily.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Numerical methods in high-performance computing (HPC) for scientific applications often require algorithmic computations such as conjugate gradient (CG) methods. Such algorithmic computations are sensitive to the precision of the underlying datatype, requiring single-precision or double-precision datatypes to run stably. Without sufficient precision, computations of great arithmetic depth accumulate numerical roundoff error over time and exhibit behaviors such as violations of physical conservation laws in physical simulations. This limits the extent to which HPC can leverage lower-precision datatypes in hardware such as float16 and bfloat16 and reduces motivation to invent novel future datatypes. Techniques are desired to adequately compensate for roundoff error in lower precision computations.

### BRIEF DESCRIPTION OF THE DRAWINGS

In the drawings:

FIG. 1 is a block diagram that depicts a microprocessor for implementing a machine learning based stabilizer for numerical methods as described herein.

FIG. 2 is a flow diagram that depicts a process for providing compensation for roundoff error using machine learning based techniques, according to an implementation.

### DETAILED DESCRIPTION

In the following description, for the purposes of explanation, numerous specific details are set forth in order to provide a thorough understanding of the implementations. It will be apparent, however, to one skilled in the art that the implementations are be practiced without these specific details. In other instances, well-known structures and devices are shown in block diagram form in order to avoid unnecessarily obscuring the implementations.
I. Overview
II. Architecture
III. Training Overview
IV. Use of Trained Models
V. Example Procedure

### I. Overview

Techniques are described herein for using machine learning to provide compensation for roundoff errors in algorithmic computations. The techniques involve training a machine learning model based on low precision data and corresponding high precision data.

The low precision data includes pairs of low precision values of a specific datatype that correspond to pairs of high precision values from the high precision data. For a pair of low precision values denoted (x_L, f(x_L)), x_L represents a low precision input value for an algorithmic computation and f(x_L) represents a low precision output value of the algorithmic computation.

The high precision data includes pairs of high precision values of a specific datatype that correspond to the pairs of low precision values from the low precision data. For a pair of high precision values denoted (x_H, f(x_H)), x_H represents a high precision input value for the algorithmic computation and f(x_H) represents a high precision output value of the algorithmic computation.

The low precision values have a lower precision than the high precision values. For example, for an algorithmic computation f(x)=sqrt(x), a pair of low precision values with 3 significant figures of precision may include the pair (x_L, f(x_L))=(4.22, 2.05) and a corresponding pair of high precision values with 6 significant figures of precision may include the pair (x H, f(x_H))=(4.22000, 2.05426).

One or more steps of a particular algorithmic computation are performed using a low precision input value as input to generate a low precision result value as output. For example, the one or more steps of an algorithmic computation may be performed using a low precision input value of a datatype with 3 significant figures of precision to generate a low precision result value with 3 significant figures of precision as output.

When the machine learning model has been trained, the machine learning model predicts a pair of high precision values that includes a high precision result value based on using a pair of low precision values comprising the low precision input value and low precision result value as input. The compensation value is determined by calculating a difference between the high precision result value and the low precision result value. The compensation value is used to compensate for roundoff error in the particular algorithmic computation.

Techniques discussed herein provide compensation for accumulated roundoff error during otherwise unstable computations, enabling HPC and other scientific applications to use lower precision data types more readily.

### II. Architecture

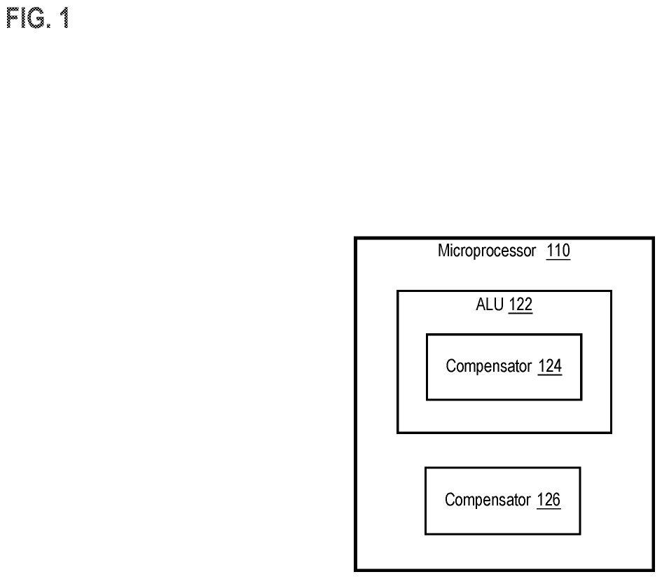

FIG. 1 is a block diagram that depicts a microprocessor 110 for implementing a machine learning based stabilizer for numerical methods as described herein. Microprocessor 110 includes arithmetic logic unit (ALU) 122 and compensator 124, 126.

In one implementation, the microprocessor 110 may be any type of Central Processing Unit (CPU), Graphics Processing Unit (GPU), application-specific integrated circuit (ASIC), or logic capable of processing commands. The microprocessor 110 may include any number of cores that may vary depending upon a particular implementation and implementations are not limited to any particular number of cores. In other implementations, microprocessor 110 may include other elements not described herein.

ALU 122 may comprise logic and/or circuitry for performing one or more computations as part of an algorithm. Computations may include addition, subtraction, address-generation, determination of an outcome of a branch conditional instruction, multiplication, division, or otherwise. For example, ALU 122 may include circuitry to perform floating-point addition, subtraction, multiplication, division, square root, integer to floating-point conversion, floating-point to integer conversion, or other. ALU 122 is not limited to performing computations for any specific datatype. In some implementations, ALU 122 may receive compensation values generated by compensator 126, 126, as further discussed herein.

Compensator 124, 126 may comprise logic and/or circuitry for implementing a machine learning model, the functionality of which is further discussed herein. In one implementation, the machine learning model comprises a neural network. In one implementation, compensator 126 is implemented by ALU 122. In another implementation, compensator 126 is implemented separately from ALU 122 as separate logic or circuitry. Training of the machine learning model is further discussed herein. Examples of compensator 124, 126 are further discussed herein.

### III. Training Overview

A training dataset includes low precision data and high precision data. The training dataset is used to train a machine learning model, as further discussed herein.

The low precision data includes pairs of low precision values of a specific datatype that correspond to pairs of high precision values from the high precision data. For a pair of low precision values denoted (x_L, f(x_L)), x_L represents a low precision input value for an algorithmic computation and f(x_L) represents a low precision output value of the algorithmic computation. For example, where the algorithmic computation is defined as f(x_L)=sqrt(x_L), f(x_L) is equal to 2.05 when x_L is equal to 4.22 for a datatype with 3 significant figures of precision.

The high precision data includes pairs of high precision values of a specific datatype that correspond to the pairs of low precision values from the low precision data. For a pair of high precision values denoted (x_H, f(x_H)), x_H represents a high precision input value for the algorithmic computation and f(x_H) represents a high precision output value of the algorithmic computation. For example, where the algorithmic computation is defined as f(x_H)=sqrt(x_H), f(x_H) is equal to 2.05426 when x_H is equal to 4.22000 for a datatype with 6 significant figures of precision.

The low precision values have a lower precision than the high precision values. For example, the low precision values may be of a float data type that contains two significant figures of precision, whereas the high precision values may be of a double data type that contains five significant figures of precision.

The training dataset may be organized into data records where each data record includes a pair of low precision values and a corresponding pair of high precision values. For example, a single data record that includes a pair of low precision values of a first datatype with 3 significant figures of precision and a corresponding pair of high precision values of a second datatype with 6 significant figures of precision may be defined as: [x_L, f(x_L), x_H, f(x_H)]=[4.22, 2.05, 4.22000, 2.05426]. The low precision data may be used as input or features to the machine learning model and the corresponding high precision data may used as output or labels to the machine learning model.

During the training phase, a machine learning model is trained using the training dataset. The machine learning model is trained to be specific to a particular algorithmic computation and a particular datatype. The particular algorithmic computation may include a function or algorithm with a finite number of steps that has at least one input and at least one output. Example algorithmic computations may include functions such as sqrt(x), cos(x), sin(x) or a multi-step algorithm. The particular datatype may be any datatype with the following properties: (a) hardware realization of arithmetic—hardware can be used to perform basic arithmetic operations such as addition, subtraction for the respective datatype (b) the datatype is monotonic—as binary numbers increase, the value of the numbers increases, and (c) representation error must be present to be compensated for.

Also, during the training phase, a loss function of the machine learning model is defined as a difference between a high precision output value f(x_H) from the training dataset and a corresponding low precision output value f(x_L) from the training dataset. In one implementation, the machine learning model comprises a neural network. Supervised learning is used to train the neural network based on the training dataset. In one implementation, the neural network includes one or more rectified linear unit (ReLU) activation functions that are associated with one or more nodes of the neural network. In another implementation, the neural network includes multiple distinct activation functions that are associated with one or more nodes of the neural network. The multiple distinct activation functions may be gated by the one or more nodes where the gates are configured to select one or more activation functions of the multiple distinct activation functions to combine into an approximation of a target algorithmic computation.

### IV. Use of Trained Models

Once the machine learning model is trained, the machine learning model can be used as a basis for determining a compensation value that compensates for roundoff error in an algorithmic computation.

For example, one or more steps of an algorithmic computation may be executed by ALU 122 of microprocessor 110. The one or more steps may include ALU 122 executing one or more calculations based on a low precision input value as input to generate a low precision result value as output. Once the low precision result value is generated, microprocessor 110 may invoke the machine learning model implemented by compensator 124, 126 as a basis for determining a compensation value that compensates for roundoff error from the algorithmic computation.

Invoking the machine learning model may include ALU 122 providing a pair of low precision values comprising the low precision input value and the low precision result value as input to the machine learning model. In response to receiving the pair of low precision values, the machine learning model predicts a pair of high precision values comprising a high precision input value and a high precision result value. The compensation value is determined by calculating a difference between the high precision result value and the low precision result value. The machine learning model can be configured to calculate the compensation value, or alternatively, the compensation value can be calculated by logic within compensator 124, 126.

The compensation value can be retrieved by ALU 122 or provided to ALU 122 to compensate for roundoff error from performing the algorithmic computation. For example, upon receiving the compensation value, ALU 122 may add or subtract the compensation value to the low precision result value that was originally generating by ALU 122 as output of the algorithmic computation.

### V. Example Procedure

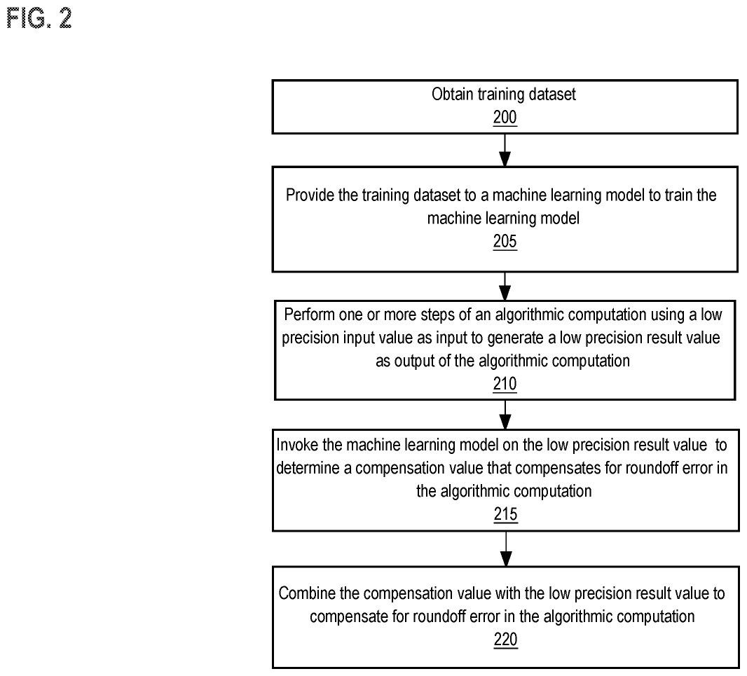

FIG. 2 is a flow diagram that depicts a process for providing compensation for roundoff error using machine learning based techniques, according to an implementation.

At step 200, a training dataset is obtained. The training dataset may include low precision data and high precision data. The low precision data may include pairs of low precision values of a specific datatype that correspond to pairs of high precision values from the high precision data. The high precision data includes pairs of high precision values of a specific datatype that correspond to the pairs of low precision values from the low precision data. The low precision values have a lower precision than the high precision values.

At step 205, the training dataset is provided to a machine learning model to train the machine learning model. The machine learning model is trained specific to a particular algorithmic computation and a particular datatype. Pairs of low precision values from the low precision data may be used as input and corresponding pairs of high precision values from the high precision data may be used as output for training the machine learning model. The machine learning model may be retrained periodically to ensure the model produces the most accurate predictions possible.

At step 210, using a low precision input value as input, one or more steps of an algorithmic computation are performed to generate a low precision result value as output. For example, one or more steps of an algorithmic computation are performed by ALU 122. Performing the one or more steps may include ALU 122 performing one or more calculations based on a low precision input value to generate a low precision result value as output of the algorithmic computation.

At step 215, the machine learning model is invoked on the low precision result value to determine a compensation value that compensates for roundoff error in the algorithmic computation. Determining the compensation value may include using the machine learning model to predict a high precision result value based on using the low precision result value as input to the machine learning model and then calculating the compensation value as a difference between the low precision result value the high precision result value. For example, microprocessor 110 invokes use of the machine learning model implemented by compensator 124, 126 using the low precision result value to predict a high precision result value. Compensator 124, 126 then determines the compensation value as a difference between the low precision result value the high precision result value.

At step 220, the compensation value is combined with the low precision result value to compensate for roundoff error in the algorithmic computation. For example, ALU 122 may receive the compensation value and add or subtract the compensation to the low precision result value that was originally generated as output from the algorithmic computation.

What is claimed is:

1. A microprocessor comprising logic configured to cause:
invoking a machine learning model as a basis for determining a compensation value that that compensates for roundoff error in an algorithmic computation;
wherein the machine learning model is trained specific to a particular algorithmic computation and a particular datatype.

2. The microprocessor of claim 1, wherein the microprocessor is further configured to cause:
using a low precision input value as input, performing one or more steps of the algorithmic computation to generate a low precision result value as output.

3. The microprocessor of claim 2, wherein the machine learning model is trained to predict a high precision result value of the algorithmic computation;
wherein the compensation value indicates a difference between the low precision result value of the algorithmic computation and the high precision result value.

4. The microprocessor of claim 2, wherein the microprocessor is further configured to cause:
combining the compensation value with the low precision result value to compensate for roundoff error in the algorithmic computation.

5. The microprocessor of claim 1, wherein training the machine learning model comprises training the machine learning model using a training dataset comprising:
pairs of low precision values, and
pairs of high precision values that correspond to the pairs of low precision values.

6. The microprocessor of claim 1, wherein the machine learning model comprises a neural network.

7. The microprocessor of claim 1, wherein the machine learning model includes one or more rectified linear unit (ReLU) activation functions that are associated with one or more nodes of the machine learning model.

8. The microprocessor of claim 1, wherein the machine learning model includes multiple distinct activation functions that are associated with one or more nodes of the machine learning model.

9. The microprocessor of claim 8, wherein the one or more nodes include gates that are configured to select one or more activation functions of the multiple distinct activation functions to combine into an approximation of a target algorithmic computation.

10. A method comprising:
invoking a machine learning model as a basis for determining a compensation value that that compensates for roundoff error in an algorithmic computation;
wherein the machine learning model is trained specific to a particular algorithmic computation and a particular datatype.

11. The method of claim 10, further comprising:
using a low precision input value as input, performing one or more steps of the algorithmic computation to generate a low precision result value as output.

12. The method of claim 11, wherein the machine learning model is trained to predict a high precision result value of the algorithmic computation;
wherein the compensation value indicates a difference between the low precision result value of the algorithmic computation and the high precision result value.

13. The method of claim 11, further comprising:
combining the compensation value with the low precision result value to compensate for roundoff error in the algorithmic computation.

14. The method of claim 10, wherein training the machine learning model comprises training the machine learning model using a training dataset comprising:
pairs of low precision values, and
pairs of high precision values that correspond to the pairs of low precision values.

15. The method of claim 10, wherein the machine learning model comprises a neural network.

16. The method of claim 10, wherein the machine learning model includes one or more rectified linear unit (ReLU) activation functions that are associated with one or more nodes of the machine learning model.

17. The method of claim 10, wherein the machine learning model includes multiple distinct activation functions that are associated with one or more nodes of the machine learning model.

18. The method of claim 17, wherein the one or more nodes include gates that are configured to select one or more activation functions of the multiple distinct activation functions to combine into an approximation of a target algorithmic computation.
